(19) United States
(12) Patent Application Publication
(10) Pub. No.: US 2011/0189933 A1
(43) Pub. Date: Aug. 4, 2011

(54) Coin Storage

(75) Inventor: Peter Höffges, Monchengladbach (DE)

(73) Assignee: Scheidt & Bachmann GmbH, Monchengladbach (DE)

(21) Appl. No.: 13/019,321

(22) Filed: Feb. 2, 2011

(30) Foreign Application Priority Data
Feb. 2, 2010 (EP) 10 001 037.0

(51) Int. Cl. G07D 1/00

(52) U.S. Cl. 453/56

(57) ABSTRACT

A coin storing apparatus has at least one receiving space for coins as well as a feeding and/or dispensing device and/or a coin overflow for feeding and/or dispensing coins. A chain that stores the coins is disposed in the receiving space. The chain has chain links each having a storage area adapted to selectively receive at least one coin. The chain is helically wound in several planes. The storage area has a holding device formed by one or more of the chain links arranged in an adjacent plane of the several planes that is adjacent to that one of the several planes where the storage area is located. The coin storing apparatus is installed in a machine such as a ticket machine.

### BACKGROUND OF THE INVENTION

The present invention relates to a coin storing apparatus comprising a receiving space for coins and a feeding and/or dispensing device for feeding and/or dispensing of coins. The invention also relates to a chain for the coin storing apparatus according to the invention and to an automatic unit, especially a ticket machine including a coin storing apparatus of the invention.

Coin storing apparatus are generally known, particularly those which are used in automatic units, so that there is no need to specifically document prior art references. A storing apparatus of this type normally comprises a receptacle to which coins are supplied via a feed channel. In said receptacle, the coins are randomly stored in an unsorted manner. If it is desired to remove coins from such coin storing apparatus, the coins must be supplied to a separator so that the coins can be dispensed in a controlled and preferably countable manner. If various types of coins are stored in the coin storing apparatus, for instance coins of a different value, additional sorting of the coins according to the coin type must be provided in a removal situation. An improvement of such a coin storing apparatus intended for different coin types is found in a coin register device that allows coins to be stored in dependence of the coin type. The coin type may be determined by a coin dimension, coin value or coin weight and/or the like. A particular design of a coin register device provides for the coins being arranged in the coin register device with their major flat sides stacked on top of each other.

A drawback of the known coin storing apparatus is that complex auxiliary equipment for feeding the coins and, particularly in the case of coin dispensing, complex sorting and counting equipment for dispensing a desired number and type of coins is needed. This restricts the possibilities for reducing the dimensions of coin-operated automatic units.

It is an object of the present invention to improve a coin storing apparatus of the aforementioned kind in a manner such as to achieve a further reduction of dimensions in the coin handling region.

### SUMMARY OF THE INVENTION

As a solution, the present invention proposes a coin storing apparatus (coin storage) comprising at least one receiving space for coins as well as a feeding and/or dispensing device and/or a coin overflow for feeding and/or dispensing coins, wherein a chain receiving the coins is arranged in the receiving space.

With the present invention, it is proposed for the first time that a chain is used not only for conveying the coins but especially also for storing the coins. Because a chain which receives the coins is arranged in the receiving space, the coins, thanks to the chain, are not stored in a stochastically and randomly distributed manner in the receiving space but are given a defined position by being received by the chain, thus also affording easy dispensing of the coins, without the necessity of complex classifying and/or dispensing mechanisms. Thus the dimensions of the coin storing apparatus can be considerably reduced. Moreover, by markings being assigned to coin storing portions of the chain, the invention enables coins to be individualized so that an individual coin can be easily located in the coin storing apparatus and be dispensed. Of course, it is also possible to store an individual coin in a storing portion assigned to this coin in the chain. This extends the range of application of the coin storing apparatus, with which it is possible to store coins which are individually assigned, for instance to a particular person, in this individually assigned manner. Moreover, it can be provided that the coin is assigned an identification, so that for dispensing a coin with a desired identification, said coin can be easily supplied to the dispensing device by moving the chain. It is thus possible to reduce and simplify the coin storing apparatus and additionally to individualize individual coins.

A coin in terms of the invention is an object which corresponds to a monetary value or which includes an authorization. The coin may mainly be a mostly round means of payment minted of metal which is generally used as money. However, coins in terms of the invention are also objects which may include an authorization, for example, transponder coins, token coins, gaming machine coins and/or the like. The coin usually has two large parallel circular surfaces, so that the coin can be rolled. But the coin can also have an angular shape, such as a triangle, a square, a polygon with n edges or the like. A polygonal coin in the form of a polygon with n edges can also include round sections.

The receiving space of the coin storing apparatus is preferably formed by an interior of a case. Particularly preferably, the case is substantially closed, thus making the access to coins in the coin storing apparatus more difficult. The receiving space can be configured in a manner adapted to the chain. The feeding and/or dispensing devices can be disposed in particular preferred areas of the receiving space. Preferably, the feeding and/or dispensing devices are formed physically adjacent to each other, preferably integrally with each other. The feeding device can be designed in such a manner that it detects a free storage area (receptacle) of the chain and feeds a coin to this free storage area (receptacle). For this purpose sensor means can be provided that are capable of detecting the presence of one or more coins in the storage area of the chain. The sensor means can be designed for example as optical, mechanical, magnetic sensor means and/or a combination thereof. The dispensing device can be an actuator-operated ejection element which removes a coin which is disposed in a storage area of the chain from this storage area and advances the coin to a dispensing unit. The dispensing unit moves the coin to be dispensed to a dispensing area in which the coin can be collected by a person or can be supplied to further handling/processing. Further, the dispensing device can comprise means for identifying an individual coin, thus achieving an individualization of the coin storing apparatus. For instance, a predetermined individual coin can be moved into the range of the dispensing device by moving the chain in the receiving space so that this special coin is forwarded to the dispensing station. Also, the feeding device can comprise individualization means, with which it is possible to individualize a coin and to store this coin in a predefined storage area of the chain. The position of the individualized coin within the chain can be memorized in accessible memory means. Of course, it can also be provided that the individualized coin is detected with the help of individualized features using sensor means, during the movement of the chain within the receiving space. The ejection element can be controlled in a corresponding manner.

The chain arranged in the receiving space can be an endless chain. It can be arranged in the receiving space in a stochastically distributed manner. However, it is particularly advantageously when the chain is wound up helically in several planes. Thus, the space for accommodating the chain can be further reduced. Moreover, this design simplifies driving of the chain because a substantially uniform power for moving the chain can be achieved. It can be avoided that the chain links become wedged together during the movement of the chain, thus also avoiding resultant problems. Moreover, the helical arrangement in several planes affords more compactness and a higher storing density in an orderly form. In this respect, one or more windings can be provided for the chain. The feeding and/or dispensing device can be disposed between two windings of the chain. The windings may have a cylindrical form, for instance a cylindrical form with a circular base, elliptical base, square base or the like.

Advantageously, the chain comprises chain links including a storage area (receptacle) adapted for preferably selectively receiving a single coin. In this way, the storage area intended for the coin can be easily incorporated in the chain. The storage area can be integrally formed with the chain link. Of course, the storage area (receptacle) can also be designed for storing several coins. But preferably, it is designed and adapted for storing a single coin and, particularly preferred, the dimensions of the storage area or receptacle are adapted and selected so as to suit this particular coin. Concerning its dimensions, the storage area can be also designed in such a manner that preferably all sizes of coins in circulation can be stored. It is also possible for the storage area to be designed for stacking several coins, especially also coins of a different type or a different size, in the storage area. The storage area or receptacle can be connected for instance as a separate component to one or more chain links.

Further, the storage area can be integrally formed with a chain link and particularly with a joint of the chain link. This affords a particularly compact and simple construction of the chain and, hence, also of the coin storing apparatus.

According to a further form of construction, the chain link can comprise a coupling arm and a coupling arm seat. This enables easy assembly of the chain, for instance also with differently designed storage areas so that the chain can be individually adapted to the desired properties of the coin storing apparatus.

Of course, the coin storing apparatus can also comprise several chains in its receiving space or receiving spaces. An individual receiving space can be provided for each chain. The design of the different chains can be adapted to different coins.

The coin storing apparatus is particularly compact and robust when the storage area is integrally formed with a joint of the chain link. A reliable operation of the chain can thus be achieved even with inexpensive materials, e.g. plastic materials or the like.

The coupling arm and the coupling seat can be articulated to each other via said joint. This increases the flexibility of the chain and affords small bending radii. Of course, it can also be provided that the storage area is formed in a part of the chain link which is not connected to the adjacent chain links, thus additionally achieving that the articulate connection between adjacent chain links can be designed optimally and without any obstruction by properties of the storage area.

According to a further embodiment, the storage area (receptacle) comprises holding means. The holding means serve to hold one or more coins in the storage area while the coins stay in the storage area. The holding means can be formed by spring elements, locking elements, levers, a fit feature or the like. The holding means can extend along the chain and can be formed, if necessary, integrally with the chain. For instance, for each storage area a separate holding means can be provided. Further, the holding means can be adjustable so as to securely hold different types or different sizes of coins in the storage area. Moreover, the holding means is preferably configured in a manner allowing coins to be fed and/or dispensed as freely as possibly. For instance, the holding means can engage at a peripheral portion of the coin, whereas the coin is fed to or dispensed from the storage area transversely to said holding means.

Further, winding means can be provided for the chain. For instance, the chain can be wound up on a pin or on a shaft. The winding means can have an external structure which is adapted to the chain and which allows the chain to be guided. Preferably, the chain can also be driven by said winding means.

The holding means can be provided by the chain, especially by an adjacent chain link. It can be provided, for instance, that the holding means is formed by one or more chain links of an adjacent plane or a plane above that plane in the helically wound-up part of the chain, thus eliminating or simplifying separate holding means.

Further, the holding means can comprise a guide rail for the chain. In this way, it can be achieved that in addition to the holding function provided for the coins in the storage area, also the chain can be guided in a desired manner. The guide rail can be integrally formed with the receiving portion. It can be made, for example, of a plastic material, sheet metal or the like.

The invention further proposes a chain for a coin storing apparatus according to the invention. By using the chain in the coin storing apparatus, the dimensions of the coin storing apparatus can be reduced and its reliability can be increased. Moreover, any additional equipment such as coin separators, coin classifiers and/or the like can be avoided.

The invention also proposes a machine or automatic unit, particularly a ticket machine, which comprises a coin storing apparatus of the present invention. By using the coin storing apparatus of the present invention, the dimensions of the automatic unit can be considerably reduced. Furthermore, the reliability of operation of the coin storing apparatus can be improved. Moreover, it is possible in a simple way to dispense individualized coins in an individually assigned manner. This is useful, for instance, in the field of parking space management, where individually assigned authorization coins are dispensed.

### BRIEF DESCRIPTION OF THE DRAWINGS

Further advantages and features will become apparent from the following description of an embodiment, wherein identical or similar parts are identified by the same reference characters and wherein reference is made to the description of the embodiment according to FIG. 1, as far as identical or similar features and functions are concerned. The drawings are schematic drawings and merely serve to illustrate the embodiment which is described in the following.

FIG. 1 shows a schematic perspective side view of a coin storing apparatus according to the present invention.

FIG. 2 shows the coin storage of FIG. 1 in a side view.

FIG. 3 is a schematic perspective side view of the coin storing apparatus according to FIG. 1 including a fully shown chain.

FIG. 4 is a schematic illustration of the path of transportation of a coin through the coin storage.

FIG. 5 shows a chain link for the chain of the coin storage according to the present invention

FIG. 6 is a schematic illustration of a chain which is formed from chain links according to FIG. 5 and arranged in a single plane.

FIG. 7 is a schematic side view of a coin-operated machine intended for transponder coins that includes a coin storage in accordance with the present invention.

### DESCRIPTION OF PREFERRED EMBODIMENTS

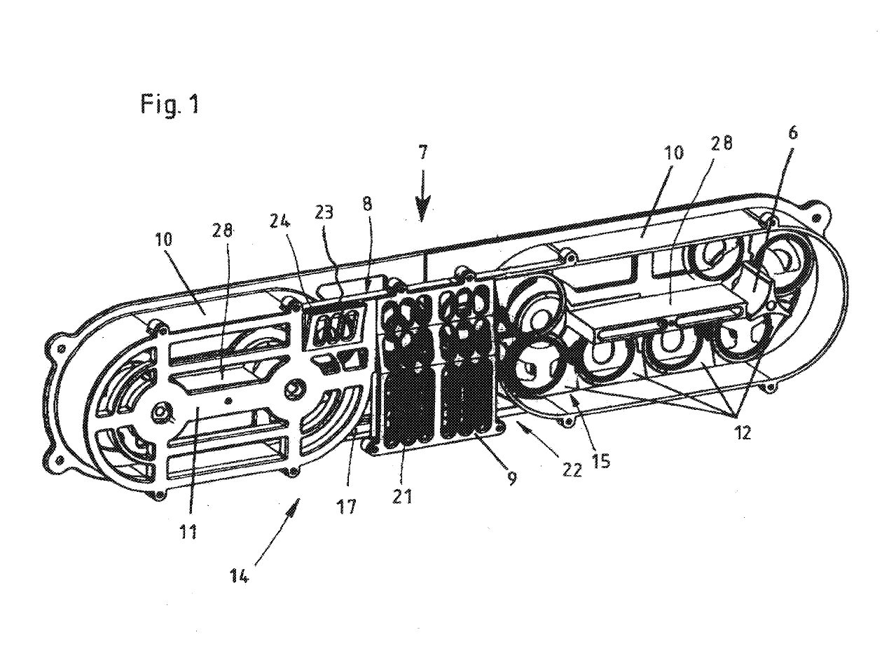

FIG. 1 illustrates in a perspective side view a coin storing apparatus (coin storage) 14 of the present invention. The coin storing apparatus or coin storage 14 comprises as a receiving space two wind-up cases 10 for a chain 15 which are oval-shaped in the present case. Depending on the requirements, the wind-up cases 10 can also have a circular or square shape or the like. Centrally between the two wind-up cases 10, a coin handling station 7 is arranged comprising a coin feeding device 8 as well as a coin returning device 21 as a dispensing device. The coin handling station 7 further comprises a coin overflow 9.

The chain 15 is arranged inside the wind-up case 10. The chain 15 is composed of chain links 1. The chain 15 is schematically indicated in FIG. 1, wherein merely the lowermost or rearmost plane in the wind-up case 10 is shown. In its wound-up state, the chain 15 is helically wound up in several planes (see FIG. 3).

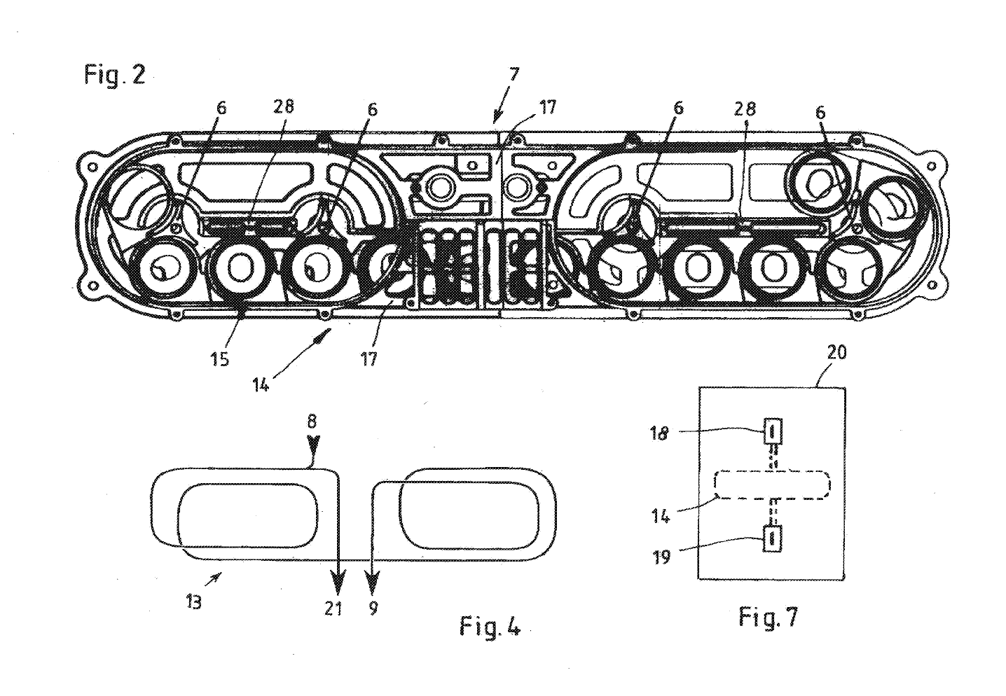

In the present case, the chain 15 is configured as an endless chain. As can be seen in FIGS. 1 and 2, the lower levels of the wind-up case 10 are in connection with each other via a connection channel 22 through which the chain 15 can pass from one wind-up case 10 to the other wind-up case 10. The connection channel 15 comprises a guide rail 17 that serves to secure guide means of the chain 15 in the connection channel.

The coin handling station 7 also forms a connection channel (not further shown) between the two wind-up cases 10, and the upper levels of the wound-up chain 15 are connected to each other through this connection channel in the two storage cases 10. In this connection channel of the coin handling station 7, the chain 15 is sequentially moved past the coin feeding device 8, the coin returning device 21 and the coin overflow 9. The present design provides for the chain 15 to be drivable in both directions.

The two movement directions of the chain 15 are the receiving direction and the returning direction. The chain 15 is controlled in such a manner that the coin feeding device 8 leads into an empty (vacant) storage area 4.

If the storage area 4 is filled by one (several) coin(s), the chain 15 is advanced by one link in the receiving direction. When the sorted coins are to be returned, for example, when the vending process is annulled or change is to be dispensed, the chain 15 moves beyond the coin feeding device 8 to the coin returning device 21 in the reverse direction (returning direction). In the coin returning device 21, the coin present in the storage area 4 is ejected through the through opening 25 by means of a push rod. The chain 15 continues to move in the returning direction (and coins are continued to be dispensed) until the desired number of coins has been dispensed. To continue storing of coins, the chain 15 is again moved by one position (first vacant storage area 4) in the storing direction up to the position of the coin feeding device 8. The coin storing apparatus 14 is replenished in the receiving direction. If a storage area 4 filled with coins arrives at the position of the coin overflow 9 in the receiving direction, this coin is pushed through an opening 25 into the coin overflow 9 by means of a push rod (not further shown). Due to the force of gravity, the coin drops through the coin overflow 21 into a cash box (not shown). To continue storing of coins, the storage area 4 thus emptied is moved in the receiving direction via the coin returning device 21 to the coin feeding device 8. This process guarantees that coins can be collected and stored in an endless fashion.

For feeding a coin, the coin feeding device 8 comprises a feeding chute 23 which, in turn, comprises a feeding slot 24. Via said feeding slot 24 a coin to be stored can be fed to the feeding chute 23, so that in the course of the predetermined movement of the chain 15, the coin can be stored in storage area 4 of the correspondingly arranged chain link 1. To this end, the feeding chute 23 is provided with a feeding ramp (not shown) which automatically moves the coin to the storage area 4 provided for it, due to the force of gravity of the coin.

FIG. 5 shows a single chain link 1 of the chain 15 in an enlarged view. The chain link 1 comprises a coupling eye 2 as a coupling arm and a coupling ring 3 as a coupling arm seat. The coupling ring 3 is formed by a circumferentially extending projection transverse to a longitudinal extension of the chain 15 and comprises on its part a recess that serves as storage area 4 for the coin to be stored. The coupling ring 3 is monolithically formed with coupling eye 2. The coupling eye 2 is substantially circular and has a circular opening that serves for receiving the coupling ring 3 of a chain link 1 to be coupled. Accordingly, the single chain link has fixing elements intended for a form-fit connection with the preceding and with the succeeding chain link, respectively. A chain 5 formed by such chain links 1 is illustrated in FIG. 6. For the sake of clarity, the chain illustrated in FIG. 6 is shown only in one plane. Coupling eyes 2 and coupling rings 3, which are adjacent, form joints 16 of the chain 5. The FIGS. 5 and 6 merely serve to illustrate the design of the chain and apply likewise to the chain 15 of the previously described embodiment. Chain 15 is different from chain 5 only by the fact that its length is dimensioned corresponding to the requirements of the coin storing apparatus 14 and that it is helically wound-up in several planes in the wind-up cases 10. Furthermore, the storage area 4 that serves as storing portion of a coin comprises a through opening 25.

The coin storage area 4 can be adapted to a predetermined size of the coin. Moreover, appropriately selecting the dimensions of storage area 4 enables storing all sizes of coins in circulation. This simplifies the use of the coin storing apparatus 14 because the same coin storing apparatus 14 can be used for coins of a different size. The present embodiment provides that the coin storing apparatus 14 stores transponder coins for parking space management. The transponder coins used for this purpose have a uniform size to which the dimensions of the coin storage area 4 are adapted. Thus, the ring of storage area 4 simultaneously serves as a holding means for the coin stored in said storage.

In their finally mounted state, the wind-up cases 10 are closed with a cover 11 which ensures that the chain 15 is securely guided in the coin storing apparatus 14 and that the chain links 1 of the chain 15 are connected to each other in a form-fit fashion during the operation as intended, independently of the position of the coin storing apparatus 14. This construction simultaneously serves as a holding means for the coins stored in the chain 15. The connection channel 22 and the connection channel formed by the coin handling station 7 are configured in a corresponding manner.

For dispensing a coin from the coin storing apparatus 14, the chain link 1 carrying the desired coin is moved to the region of the coin returning device 21. In this region, a push rod is provided (not shown) which is operated on reaching a dispensing position and ejects the coin stored in the storage area 4 of the corresponding chain link 1 by the push rod being moved through the opening 25 of the corresponding chain link 1, thus pushing the coin out of the storage area 4. Due to the force of gravity, the coin then drops through the coin returning device 21 and is advanced to a coin dispensing station. After dispensing of the coin, the push rod is returned and the chain transported farther. Of course, it can be provided that the chain 15 is stopped for dispensing the coin. Moreover, the coin storing apparatus 14 can be designed in such a manner that dispensing is possible also during the movement of the chain 15.

FIG. 2 shows the drive of the chain 15. In each of the two wind-up cases 10 a pinion 6 is disposed at the turning point of the chain 15 which is driven by a driving unit (not further shown). In the present case all pinions 6 are driven. Of course, it can be provided that only one or one of the pinions disposed in each of the wind-up cases 10 is driven. Each pinion 6 engages with its pinion arms (not referenced) in a recess 27 of the chain links 1 (compare FIG. 5). Thus the chain 15 is guided and simultaneously driven. In the present case, it is provided that the pinions 6 have an extension in the direction of the axis of rotation which at least covers the height of the chain 15 that is helically arranged in several planes or levels in one of wind-up cases 10, thus achieving a uniform transmission of forces from the pinion 6 to the chain 15.

For better guiding the chain 15, a web 28 is disposed between the two drive pinions 6 of a respective wind-up case 10. This improves guiding of the chain 15, especially in different positions of installation of the coin storing apparatus 14.

The arrangement of the chain 15 in a receiving space (case 10) of the coin storing apparatus 14 makes it possible to flexibly and individually design the coin storing apparatus in a simple way using available components in the manner of a modular system. Thus, the coin storing apparatus can be customized according to individual requirements at low cost and within a short time.

FIG. 4 illustrates the general path of movement of a coin through the coin storing apparatus 14, from the coin feeding device 8 up to the coin overflow 9, and also the path to the coin returning device 21. As can be seen, a coin that has been fed is stored in the chain 15 and is conveyed through the left wind-up case 10 (FIGS. 1, 2) through all the levels until it reaches, via connecting channel 22, the right wind-up case 10 and is again guided through all the levels of the wound-up chain 15 until it reaches the coin overflow 9. Through a chute (not further illustrated) the coin is conveyed from the coin overflow 9 to a cash box (not shown) where it remains until the operator of the system or the service personnel remove the coin manually. This technique ensures an endless coin acceptance. Coins are returned to the customers via the coin returning device 21.

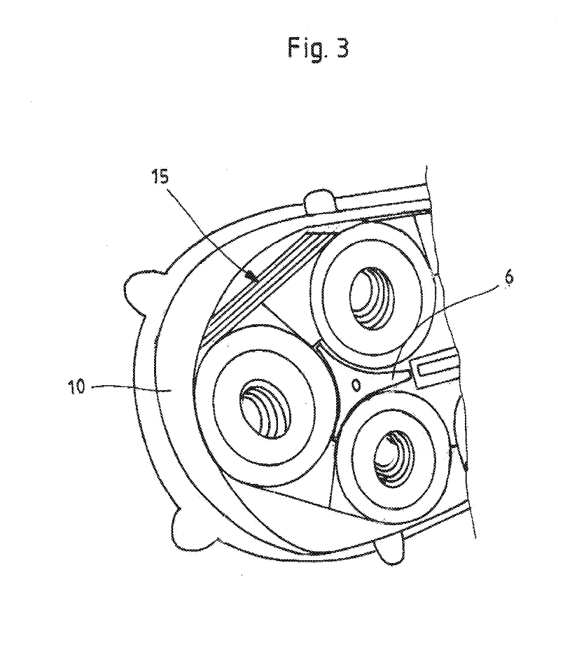

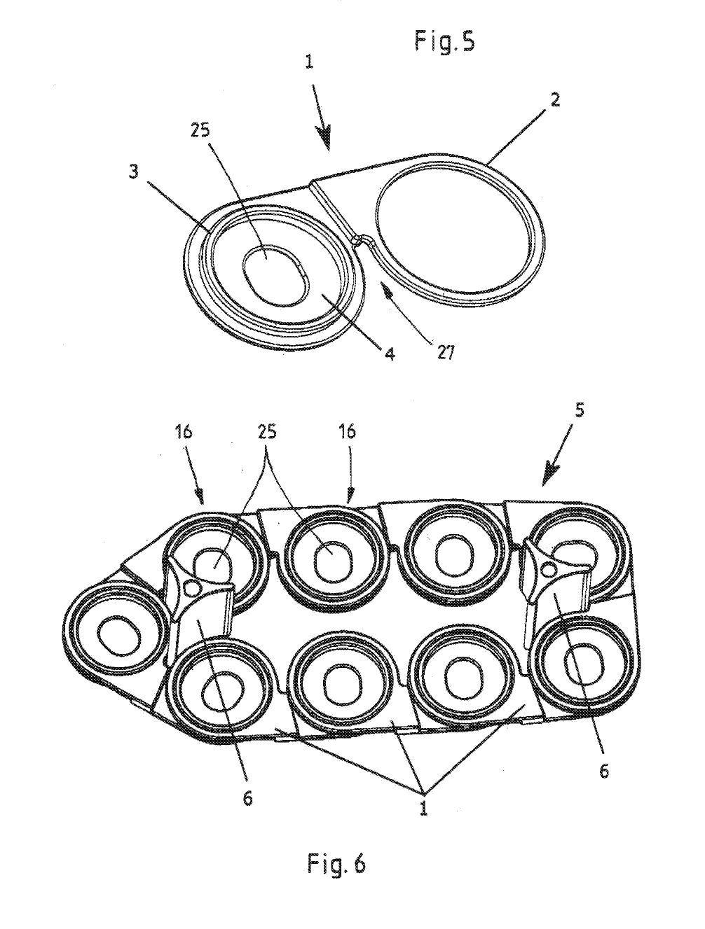

FIG. 7 shows a coin-operated machine 20 (automatic unit) for feeding and dispensing transponder coins of the kind used in parking space management. The machine is schematically represented in FIG. 7 and comprises a coin slot 18 and a coin dispensing station 19. In the machine 20, a coin storing apparatus (coin storage) 14 of the invention is mounted. The coin slot 18 is connected with the coin feeding device 8 via connection channels (not shown), and the coin dispensing device 19 is connected with the coin returning device 21. Not illustrated are the cash box and connection chute from the coin overflow 9 to the cash box.

When such a machine 20 is installed for instance at a barrier of a managed parking space, the coin slot 18 can be disposed on the entrance side and the coin dispensing station 19 can be oppositely disposed on the exit side at the rear side of the machine 20. If a vehicle is intended to be parked in a managed parking space, the user steers his vehicle to the machine 20. Via a corresponding sensor the machine 20 detects that access to the parking space is desired for a vehicle. A corresponding coin is automatically dispensed by being removed from the coin storing apparatus 14 in the manner as described above and is dispensed at the coin dispensing station 19. The driver collects the coin at the coin dispensing station 19; this is detected by the machine 20. As a result, the machine 20 opens a barrier (not further shown) thus allowing the vehicle to access the parking space. The barrier is closed again by the machine 20 after the vehicle has passed.

At the time of leaving the parking space, the user inserts the coin 20 in the coin slot 18, whereupon the machine 20 first checks the coin for validity and thereafter feeds the coin to the coin storing apparatus 14. At the same time, a barrier (not further illustrated) is opened, so that the vehicle can leave the parking space. The barrier is closed again by the machine 20 after the vehicle has passed.

Not described are the known techniques for validating a transponder coin. It can be provided, for instance, that the transponder coin is provided at the time of dispensing with data regarding the dispensing time. The process of checking validity may involve reading of an authorization programmed to the transponder coin at a pay machine. The barrier is opened only when a valid authorization exists.

The specification incorporates by reference the entire disclosure of European patent application 10 001 037.0 having a filing date of Feb. 2, 2010 of which application priority is claimed for the Instant application for patent.

While specific embodiments of the invention have been shown and described in detail to illustrate the inventive principles, it will be understood that the invention may be embodied otherwise without departing from such principles.

### LIST OF REFERENCE NUMBERS

1 single chain link
2 coupling eye
3 coupling ring
4 coin storage
5 arrangement of several chain links in one plane
6 drive pinion
7 coin handling
8 coin feeding device
9 coin overflow
10 wind-up case
11 cover
12 chain links of a plane
13 principal movement path of a coin through the coin storing apparatus
14 coin storing apparatus
15 chain
16 joint
17 guide rail
18 coin slot
19 coin dispensing station
20 machine
21 coin returning device
22 connection channel
23 feeding chute
24 feeding slot
25 through opening
27 recess
28 web

What is claimed is:

1. A coin storing apparatus comprising:
at least one coin receiving space;
a feeding device;
a chain that receives coins and is arranged in said receiving space;
said chain having chain links each having a storage area, wherein said storage area is adapted to selectively receive at least one coin,
wherein said chain is helically wound in several planes;
wherein said storage area comprises a holding means;
wherein said holding means is formed by one or more of said chain links arranged in an adjacent plane of said several planes, said adjacent plane disposed adjacent to that one of said several planes where said storage area is located.

2. The coin storing apparatus according to claim 1, wherein said storage area is integrally formed with said chain link.

3. The coin storing apparatus according to claim 1, wherein said chain links each comprise a coupling arm and a coupling arm seat.

4. The coin storing apparatus according to claim 3, wherein said coupling arm of a first one of said chain links and said coupling arm seat of a second one of said chain links disposed adjacent to said first chain link are articulated to each other by a joint.

5. The coin storing apparatus according to claim 1, comprising winding means acting on said chain.

6. The coin storing apparatus according to claim 1, wherein said holding means is provided by said chain.

7. The coin storing apparatus according to claim 1, wherein said holding means comprises a guide rail for said chain.

8. A chain for a coin storing apparatus according to claim 1, said chain comprising:
chain links each having a storage area, wherein said storage area is adapted to selectively receive at least one coin;
wherein said chain is helically wound in several planes;
wherein said storage area comprises a holding means;
wherein said holding means is formed by one or more of said chain links arranged in an adjacent plane of said several planes, said adjacent plane disposed adjacent to that one of said several planes where said storage area is located.

9. The chain according to claim 8, wherein said storage area is integrally formed with said chain link.

10. The chain according to claim 8, wherein said chain links each comprise a coupling arm and a coupling arm seat.

11. The chain according to claim 10, wherein said coupling arm of a first one of said chain links and said coupling arm seat of a second one of said chain links disposed adjacent to said first chain link are articulated to each other by a joint.

12. The chain according to claim 8, comprising winding means acting on said chain.

13. An automatic unit comprising a coin storing apparatus according to claim 1.
